(19) United States
(12) Patent Application Publication
(10) Pub. No.: US 2026/0124795 A1
(43) Pub. Date: May 7, 2026

(54) POLYMERIC ARTICLES FOR APPLICATIONS IN VEHICLES AND METHODS OF MAKING THE SAME

(71) Applicant: CORE MOLDING TECHNOLOGIES, INC., Columbus, OH (US)

(72) Inventors: Daniel CORDIDO, Columbus, OH (US); Jordan PELZI, Columbus, OH (US); Eric PALOMAKI, Columbus, OH (US); Vinod ARORA, Boiling Springs, SC (US)

(21) Appl. No.: 19/427,978

(22) Filed: Dec. 19, 2025

Related U.S. Application Data
(60) Provisional application No. 63/716,661, filed on Nov. 5, 2024.

(51) Int. Cl. B29C 45/17; B29C 45/00; B29K 23/00; B29K 309/08; B29L 7/00; B29L 31/30

(52) U.S. Cl. CPC B29C 45/1701; B29C 45/0005; B29K 2023/065; B29K 2023/12; B29K 2309/08; B29K 2995/0089; B29K 2995/0097; B29L 2007/002; B29L 2031/3055; B29L 2031/307

(57) ABSTRACT

A molded article is disclosed made from a composition comprising a thermoplastic polymer for use as an impact resistant structure for a vehicle, for example an off-road vehicle. The molded article can have an average thickness or a maximum thickness of 5 mm to 14 mm and is configured to absorbed at least 355 joules of force without forming an open puncture from an impact surface of the article to an opposing surface of the article.

### CROSS-REFERENCE TO RELATED APPLICATION

This application claims priority to and the benefit of U.S. Provisional Patent Application No. 63/716,661 , filed Nov. 5, 2024, which is incorporated by reference herein in its entirety.

### FIELD OF INVENTIONS

The present inventions relate to articles made from polymeric materials and methods of making the same. More specifically, the present inventions relate to molded thermoplastic materials with improve impact resistance and high wear use properties for vehicles.

### BACKGROUND

The popularity of off-road vehicles (ORVs), a category of vehicles which includes recreational off-road vehicles (RORVs), all-terrain vehicles (ATVs), and utility task vehicles (UTVs), has dramatically increased and continues to rise. In 1998 an estimated 35,000 units were sold in the United States. The number of units sold has risen to well over 2 million. ORVs are intended to be driven off-road or off-highway and are specifically designed to have all-terrain capabilities. Common uses for ORVs include farm work, hunting, recreation, and trail riding. ORVs are driven in wooded areas and trails, where the vehicles are intended to traverse hazardous and rough terrains with pits, rocks, tree branches, and sticks. The U.S. Consumer Product Safety Commission (CPSC) has determined that there is an unreasonable risk of injury and death associated with ORVs caused by debris penetration, even if operated at lower speeds. Tree branches and sticks are known to crack and penetrate through the floorboard of the underside and into the occupant area or cabin. When such penetration occurs, there is a risk that the branch or other debris penetrates far enough into the vehicle to injure or cause death to the occupants. Reported injuries have involved lacerations, bruises, abrasions, broken bones, and impalement of lower body extremities and the abdomen. CSPC reported over 100 incidents of injury and 6 fatalities between 2009 and 2021 involving debris penetration and well over 600 incidences of debris cracking or breaking through the floorboards which could have led to injuries.

With ORVs (as well as other type of trucks and marine vehicles) composite body parts are rapidly replacing metals because composites offer many advantages over their counterpart metal components. Composite materials are inexpensive, and the parts are easier and less expensive to manufacture, especially customized components. Moreover, composite components are easier to install, have a higher degree of recyclability, are rust and corrosion resistant, light weight, flexible, dent resilient, and provide a greater degree of noise reduction. However, current composites in the market have failed to provide the same strength and protection offered by the metallic parts, especially for skid plates and boat hulls where improved impact and penetration resistance, toughness, and durability is of extreme importance. Simple glass fiber, glass reinforced material, and un-reinforced plastic materials cannot withstand the stresses endured in ORV use, unless the component is made very thick—which makes the article unpractical and cost prohibitive.

Accordingly, there is a great need for suitable materials and processes to produce cost-effective ORV (and other vehicular) components of various shapes and designs with improved impact and penetration resistance, toughness, and durability.

### SUMMARY

In accordance to one aspect of the inventions, a method of manufacturing an impact resistant article for a vehicle is provided, comprising: injection molding a composition comprising a thermoplastic polymer to produce an impact resistant article for a vehicle configured to absorbed 355 Joules of force without forming an open puncture from an impact surface of the article to an opposing surface of the article. The injection molding can be conducted in the presence of nitrogen gas in an amount of 5% to 15% by volume of the total volume of the composition. The thermoplastic polymer can additionally include glass fiber, wherein the glass fiber is from 30% to 65% by weight of the total weight % of the composition. The thermoplastic polymer can additionally include uni- or single directional fiberglass, wherein the fiberglass is from 30% to 65% by weight of the total weight % of the composition. The article can have an average thickness or a maximum thickness of 3 mm to 14 mm. The method can include shaping the article into a skid plate for an off-road vehicle, wherein the skid plate can absorb 355 Joules of force from a stick or a branch without forming an open puncture from an impact surface of the skid plate to an opposing surface of the skid plate when the off-road vehicle travels at a speed of 16 mph or less. The vehicle can be a boat hull, and the method additionally comprises shaping the article into a boat hull. The thermoplastic polymer can be selected from a group consisting of an acrylonitrile butadiene styrene (ABS) homo-or co-polymer, a polypropylene homo-or co-polymer, a polyethylene homo- or co-polymer, a polystyrene homo-or co-polymer, a polyamide homo-or co-polymer, and a high-density polyethylene (HDPE) homo-or co-polymer.

In accordance to one aspect, an off-road vehicle having a skid plate with an average thickness or maximum thickness of 3 mm to 14 mm for protection of occupants against penetration of objects encountered during normal course of off-road operation is provided. The skid plate can be made in accordance with the above-described method. The skid plate can prevent penetration of branches and sticks through the skid plate at a speed of up to 16 miles per hour.

In accordance to one aspect, a method of manufacturing an impact resistant article for a vehicle is provided, comprising: molding a composition comprising a thermoplastic polymer to produce an article having an average thickness or a maximum thickness of 3 mm to 14 mm and configured to absorbed 355 joules of force without forming an open puncture from an impact surface of the article to an opposing surface of the article. The molding can include a molding operation selected from a group consisting of injection molding, transfer injection molding, low pressure injection molding, compression molding, and compression transfer molding. The molding can be a gas-assisted injection molding process with nitrogen gas being applied in an amount of 5% to 15% by volume of the total volume of the composition. The thermoplastic polymer can be a homopolymer, a copolymer, a random polymer, or a graft polymer having units selected from a group consisting of an acrylic; a polyester; an acrylonitrile butadiene styrene (ABS); a polyamide or a nylon; a polylactic acid or a polylactide; a polybenzimidazole ((PBI); a polycarbonate (PC); a polyether sulfone (PES) or a polysulfone; a polyoxymethylene ((POM); a polyaryletherketone (PAEK); a polyetherimide (PEI); a polyethylene; a polyphenylene oxide (PPO); a polyphenylene sulfide (PPS); a polypropylene (PP); a polystyrene; a polyvinyl; a polyvinyl chloride (PVC); a polyvinylidene fluoride (PVDF); a polytetrafluoroethylene (PTFE); a high-density polyethylene (HDPE), and combination or mixtures thereof. The composition can additionally include glass fiber, wherein the glass fiber is from 30% to 65% by weight of the total weight % of the composition. The composition can additionally include uni- or single directional fiberglass, wherein the fiberglass is from 30% to 65% by weight of the total weight % of the composition.

In accordance to one aspect, an off-road vehicle having a skid plate is provided comprising a molded thermoplastic sheet layer or sheet layers, wherein the skid plate has an average thickness or maximum thickness of 3 mm to 14 mm, and is configured to absorb 355 joules of force without forming an open puncture from an impact surface of the skid plate to an opposing surface of the skid plate; and wherein the skid plate prevents penetration of branches and sticks through the skid plate at a speed of up to 16 miles per hour.

### BRIEF DESCRIPTION OF DRAWINGS

FIGS. 1A and 1B illustrate an example of an impact test apparatus for measuring the amount of unit of energy in Joules applied to the article.

FIGS. 2A and 2B are side and front view of an off-road vehicle (ORV) having a skid plate in accordance with one embodiment of the invention.

FIG. 3 shows a hull of a pontoon boat made from an article of the present invention.

FIG. 4 is a schematic illustration of an injection molding apparatus.

FIG. 5 is a schematic illustration of a low-pressure injection molding apparatus.

FIGS. 6A and 6B are schematic illustrations of a compression molding apparatus.

FIG. 7 is a schematic illustration of a gas-assisted injection molding apparatus.

FIG. 8 is an example of the impact test apparatus for measuring the amount of unit of energy in Joules applied to a sample of an article.

FIG. 9A-9K are photographs of the test samples indicating the amount of unit of energy in Joules applied to the articles and the impact results on the articles.

### DESCRIPTION OF EXEMPLARY EMBODIMENTS

The present inventions are related to articles made from polymeric material(s) and methods of making the same. The articles can be made from a molded thermoplastic polymer and/or polymers manufactured to have improved dynamic impact properties for structural reinforcement of vehicles. The articles can be corrosion and rust resistant, scratch resistant, durable, impact or dent resilient, and impervious to penetration (e.g., by a branch, log, or stick) during normal course of operation. The article can be thin, lightweight, and easily customizable, moldable, and installable. The article can have a low coefficient of friction, high vibration absorption, and noise reduction properties, making it ideal for application to vehicles, particularly off-road vehicles (ORVs).

Although the below descriptions refer to “embodiments,” any one of the described features or embodiments can be used, implemented, or combined with any other of the features or embodiments described herewith.

As used herein, the singular forms “a”, “an” and “the” are intended to include the plural forms, unless the context clearly indicates otherwise. For example, a “thermoplastic polymer,” “additive,” “sheet,” or “layer” can be more than one (e.g., a combination or mixture) of polymers, additives, sheets, and layers unless specifically indicated to the contrary.

It will be further understood that the terms “comprises,” “comprising,” “includes,” “including,” “has,” and/or “having” when used in this specification, specify the presence of stated features, steps, operations, elements, and/or components, but do not preclude the presence or addition of one or more other features, steps, operations, elements, components, and/or groups thereof.

As used herein, “made from” or “constructed from,” unless specifically indicated otherwise, means that the article includes materials other than what has been stated. For example, an article made from or constructed from “A” means that the articles may include “B”, unless indicated otherwise.

As used herein, the term “and/or” includes any and all combinations of one or more of the associated listed items and may be abbreviated as “/”.

A vehicle as defined herein includes any mechanism designed for self-propulsion, usually to transport people, cargo, or both. Vehicles include wagons, bicycles, motor vehicles, electrical-powered vehicles, hybrid (gas/electric) vehicles, railed vehicles (e.g., trains and trams), watercrafts (e.g., boats, jet skis, pontoon boats, ships, yachts, and underwater vehicles), amphibious vehicles (e.g., screw-propelled vehicles and hovercraft), aircraft (e.g., planes, helicopters, and aerostats), and spacecraft. Examples of motor vehicles include motorcycles, motor cars, electrical cars, hybrid cars, trucks, buses, and powered wheelchairs and scooters for disabled people. The materials of the present inventions are particularly suited for off-road vehicles (ORVs). ORVs can include utility-task or utility train vehicles (UTVs), recreational-type vehicle (RTVs) or all-terrain vehicles (ATVs). A UTV is a larger type of ATV designed to haul heavier loads and perhaps allow one or more passengers (e.g., 2-4 riders). UTV have also been called “S×S” or side-by-side vehicles. ATVs are primarily used for recreation, whereas UTVs are often used for professional tasks such as farming or landscaping. Typically, an ATV is designed for single riders, the most common ATVs are four-wheelers/quads.

In one embodiment, the article can be a component of a vehicle's body, a panel, tailgate, a bumper, or a frame or the article can be a part or section of a body, panel, tailgate, bumper, or a frame, including, but not limited to a skid plate, a wheel well cover, and a boat hull. In one preferred embodiment, the article is a skid plate for an ORV or boat hull, or a part or section of the skid plate. The article comprises a layer or sheet made from a material comprising, consists essentially of, or consist of a thermoplastic polymer. The article can be a single layer, or two or more layers bonded (e.g., with an adhesive), laminated, chemically attached, or mechanically coupled (e.g., friction fit or with a screw) to each other. The article can be a fabricated shaped layer according to the embodiments of the present inventions that is installed on or attached to an existing skid plate, well cover, or boat hull. The sheet layer can be manufactured as a continuous (one) piece, that is, without seems, and can be molded, shaped, and/or cut for its intended use. In one preferred embodiment, the article (e.g., a skid plate, wheel well cover, or boat hull) can be constructed of either a single sheet or multiple sheets. The single sheet or multiple sheets (e.g., for the finished article or the finished constructed skid plate) can have a total average thickness of 3 mm to 14 mm or a maximum thickness of 3 mm to 14 mm, more preferably from 5 mm to 12 mm, and most preferably 6 mm to 10 mm (average or max thickness).

The article (e.g., skid plate) or single sheet or multiple sheets having the aforementioned thicknesses is/are configured to absorbed 355 Joules of impact energy, preferably 400 Joules, preferably 460 Joules without forming an open puncture from the impact surface of the article or sheet to the opposing surface of the article or sheet. In one embodiment, the article or sheet(s) can absorb 1 - 500 Joules of impact energy (and any specific value in-between). In one embodiment, Joules can be measured with the following apparatus and test:

A test can be conducted on the impact zone for the worst-case vehicle configuration. The test sample may be a partial assembly or full vehicle assembly.

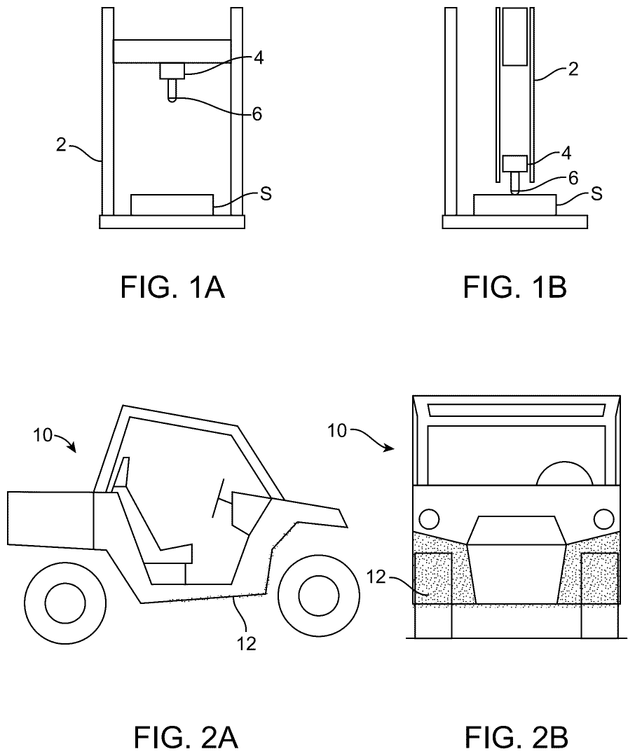

The test sample can be the type of coupons used for material testing that is reflective of actual use as is known in the art. A partial assembly can be fixtured as installed in the vehicle. FIGS. 1A and 1B illustrates the mechanism used to measure Joules. A test fixture includes a guide 2 to guide a weight 4 to be dropped accurately at test location on a sample S without moving off course. An impactor 6 should be sufficiently long so as to allow it to penetrate completely through the sample S. An 80 lbs. (36 Kg) drop weight is used. The test is conducted at 20 deg C +/−5 C. Average of 3 tests within the impact zone are conducted. The impactor strikes normal to the surface of sample S at three (3) selected points. The sample S is rigidly mounted relative to the test fixture. To exert impact energy of 355 Joules, weight of 36 Kg needs to drop from the height of 100 cm or 1 m. This approximately simulates the impact speed 10 m/h or 16 km/h. Partial deformation from the impactor is considered acceptable, but full penetration is a failure.

A skid plate is defined by its ordinary meaning in the art, which includes an abrasion-resistant or resilient material affixed to the underside of a vehicle (which as definition herein includes watercrafts, etc.) to prevent damage to the underside when contact is made with the ground or debris. In accordance to one embodiment of the inventions, FIGS. 2A and 2B illustrate an article for an S×S ORV 10 in the form of a skid plate 12. The skid plate 12 is attached to the underside of the S×S ORV 10, covering the driver and passenger front sides of the vehicle, to protect the driver and passenger from injury or death caused by debris penetration when the ORV is operated at its intended speeds. In one embodiment, the articles of the present inventions are intended to be used for speeds not greater than 20 miles per hour (mph), preferably not greater than 16 mph, and most preferably not greater than 10 mph. In one embodiment, the articles can be used for speeds of 1 mph to 35 mph. Tree branches and sticks will be prevented from cracking and penetrating through the floorboard of the underside of the ORV 10 and into the occupant area or cabin, thus saving the driver and passenger from lacerations, bruises, abrasions, broken bones, and impalement of lower body extremities and the abdomen. Additionally, the lower co-efficient friction provided by the skid-plate can not only divert debris, but also provide for better maneuverability of the ORV over rough terrain.

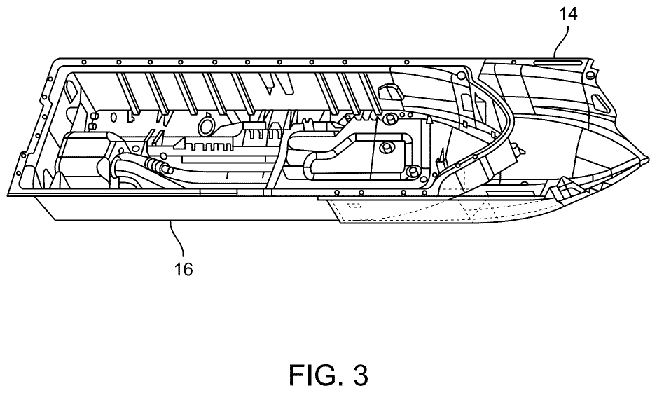

A boat hulls is defined by its ordinary meaning in the art, which includes a watertight body of a ship, boat, submarine, or flying boat. A hull may be open at the top, or it may be fully or partially covered. In accordance to one embodiment of the inventions, FIG. 3 illustrate a pontoon boat 14 having a hull 16 made from the article of the present inventions. The hull 14 can, therefore, be made thin, lightweight, and easily customizable, moldable, and installable. The hull 14 can have a low coefficient of friction, high vibration absorption, and sound absorption properties, making it ideal for watercraft uses.

A wheel well is defined by its ordinary meaning in the art, which includes the space in a vehicle's structure where the wheel is positioned.

A thermoplastic polymer is defined by its ordinary chemistry definition, and includes any plastic polymer material that becomes pliable or moldable at a certain elevated temperature and solidifies upon cooling. The polymer chains associate by intermolecular forces weaken rapidly with increased temperature, yielding a viscous liquid. In this state, thermoplastics may be reshaped, and can be used to produce components or parts of the embodiments of the present inventions by various polymer processing techniques including injection molding, compression molding, calendering, and extrusion. Above its glass transition temperature and below its melting point, the physical properties of a thermoplastic change drastically without an associated phase change. Brittleness can be decreased with the addition of plasticizers, which increases the mobility of amorphous chain segments to effectively lower the glass transition temperature. Brittleness can also be altered by copolymerization or through the addition of non-reactive side chains to monomers before polymerization. The linear or slightly branched long chain molecules are capable of repeatedly softening on heating and hardening on cooling, thus preventing vehicular components or parts from crack when exposed to cold temperatures.

Examples of thermoplastic polymers or compounds that can be used herein for the articles include acrylics (e.g., polyacrylic acids (PAA), poly(methyl methacrylate) (PMMA), and ester derivates thereof); polyesters; acrylonitrile butadiene styrene (ABS) (i.e., terpolymer synthesized from styrene and acrylonitrile in the presence of polybutadiene); polyamides (e.g., nylon); polylactic acid or polylactide; polybenzimidazole ((PBI) short for poly-[2,2′-(m-phenylen)-5,5′-bisbenzimidazole]); polycarbonate (PC); polyether sulfone (PES) or polysulfone; polyoxymethylene ((POM), also known as acetal, polyacetal and polyformaldehyde); polyaryletherketone (PAEK) (e.g., polyether ether ketone (PEEK)); polyetherimide (PEI); polyethylene (or polyethene, polythene, PE, including ultra-high-molecular-weight polyethylene (UHMWPE), high-density polyethylene (HDPE), and medium-density polyethylene (MDPE)); polyphenylene oxide (PPO); polyphenylene sulfide (PPS); polypropylene (PP); polystyrene; polyvinyl including polyvinyl chloride (PVC) and polyvinylidene fluoride (PVDF); and polytetrafluoroethylene (PTFE). In one embodiment, the thermoplastic polymer used is a homopolymer, a copolymer, a block copolymer, a random polymer, or a graft polymer. In one embodiment, the thermoplastic copolymer can include non-thermoplastic monomer or oligomer unit(s). In one embodiment, the thermoplastic polymer can be a mixture, blend, or combination of the aforementioned thermoplastic polymers or a thermoplastic polymer with a non-thermoplastic polymer (e.g., thermoset polymer). The article can comprise, consists essentially of, or consist of the thermoplastic polymer.

In one embodiment, the thermoplastic polymer used in the embodiments of the present inventions comprises, consists essentially of, or consists of a polypropylene (PP) homopolymer (i.e., propylene monomer units composed of three-carbon alkane units [—CH2(CH3)CH2]). In one embodiment, the thermoplastic polymer used in the embodiments of the present inventions comprises, consists essentially of, or consists of a polypropylene copolymer, which can include, for example, monomer or oligomer units of styrene, amides, acrylate, acrylonitrile, and butadiene. The polypropylene (PP) homopolymer or copolymer can be a mixture, blend, or combination with a thermoplastic polymer or with a non-thermoplastic polymer (e.g., thermoset polymer).

In one embodiment, the thermoplastic polymer used in the embodiments of the present inventions comprises, consists essentially of, or consists of a polyethylene homopolymer. In one embodiment, the thermoplastic polymer used in the embodiments of the present inventions comprises, consists essentially of, or consists of a polyethylene copolymer, which can include, for example, monomer or oligomer units of propylene, styrene, amides, acrylate, acrylonitrile, and butadiene. The polyethylene homopolymer or copolymer can be a mixture, blend, or combination with a thermoplastic polymer or with a non-thermoplastic polymer (e.g., thermoset polymer).

In one embodiment, the thermoplastic polymer used in the embodiments of the present inventions comprises, consists essentially of, or consists of a polystyrene homopolymer. In one embodiment, the thermoplastic polymer used in the embodiments of the present inventions comprises, consists essentially of, or consists of a polystyrene copolymer, which can include, for example, monomer or oligomer units of propylene, amides, acrylate, acrylonitrile, and butadiene. The polystyrene homopolymer or copolymer can be a mixture, blend, or combination with a thermoplastic polymer or with a non-thermoplastic polymer (e.g., thermoset polymer).

In one embodiment, the thermoplastic polymer used in the embodiments of the present inventions comprises, consists essentially of, or consists of a polyamide homopolymer (e.g., nylon). In one embodiment, the thermoplastic polymer used in the embodiments of the present inventions comprises, consists essentially of, or consists of a polyamide copolymer, which can include, for example, monomer or oligomer units of propylene, styrene, acrylate, acrylonitrile, and butadiene. The polyamide homopolymer or copolymer can be a mixture, blend, or combination with a thermoplastic polymer or with a non-thermoplastic polymer (e.g., thermoset polymer).

In one embodiment, the thermoplastic polymer used in the embodiments of the present inventions comprises, consists essentially of, or consists of an acrylonitrile butadiene styrene (ABS) homopolymer. In one embodiment, the thermoplastic polymer used in the embodiments of the present inventions comprises, consists essentially of, or consists of an ABS copolymer, which can include, for example, monomer or oligomer units of propylene, styrene, acrylate, acrylonitrile, and butadiene. The ABS homopolymer or copolymer can be a mixture, blend, or combination with a thermoplastic polymer or with a non-thermoplastic polymer (e.g., thermoset polymer).

In one preferred embodiment, the thermoplastic polymer is Thermotuff. In one embodiment, the article can have a layer of Thermotuff attached thereto.

In one embodiment, the thermoplastic polymeric article can include fiberglass—also referred to as glass-reinforced plastic (GRP) or glass-fiber reinforced plastic (GFRP), terms which are used interchangeably. In one embodiment, the thermoplastic polymeric article can include uni-or single directional fiberglass. The amount of fiberglass or unidirectional fiberglass added to the thermoplastic polymer can be from 30% to 65% by weight of the total weight % of the thermoplastic polymer and fiberglass. In one embodiment, the thermoplastic polymer does not include any fiberglass reinforcement.

Fiberglass is defined by its ordinary material definition, which is fiber-reinforced composite material or a fiber-reinforced plastic using glass fiber. Glass fiber is a material consisting of numerous extremely fine fibers of glass. The fibers may be randomly arranged, flattened into a sheet called a chopped strand mat, or woven into glass cloth. A unidirectional fiberglass is defined by its ordinary material definition, which is a glass reinforced plastic in which the fiber is oriented in one direction. Orientation in one direction means at least a majority of fibers or rovings run in one direction only. Small amount of the fibers or rovings may run in the other direction. Glass fibers can be added to the thermoplastic polymer matrix (e.g., nylon) during, for example, coextrusion, injection molding, or compression molding. The amount of glass or unidirectional fiberglass added to the thermoplastic polymer during coextrusion, injection molding, or compression molding can be from 30% to 65% by weight of the total weight of the composition. The addition of glass fibers offers rigidity and strength.

In one embodiment, the article can be a long-fiber-reinforced thermoplastic (LFRT) compound. Fiber glass, with a suitable binder is introduced into the in-line single/multi-head extruder along with pre-compounded polymer(s) pellets, colorants, other performance additives, etc. The LFRC compounds can be 5-13 mm in length. LFRT includes Long Fiber Thermoplastics (LFT) and Direct Long Fiber Thermoplastics (D-LFT) processes used for fiberglass reinforcement of thermoplastic compounds, including polypropylene or polyamide. Extruded mass is then injected or placed in the mold depending upon injection or compression molding process.

The articles of the present inventions can be manufactured by one of injection molding, transfer injection molding, low pressure injection molding, compression molding, compression transfer molding, or gas-assisted injection (GAIN) molding.

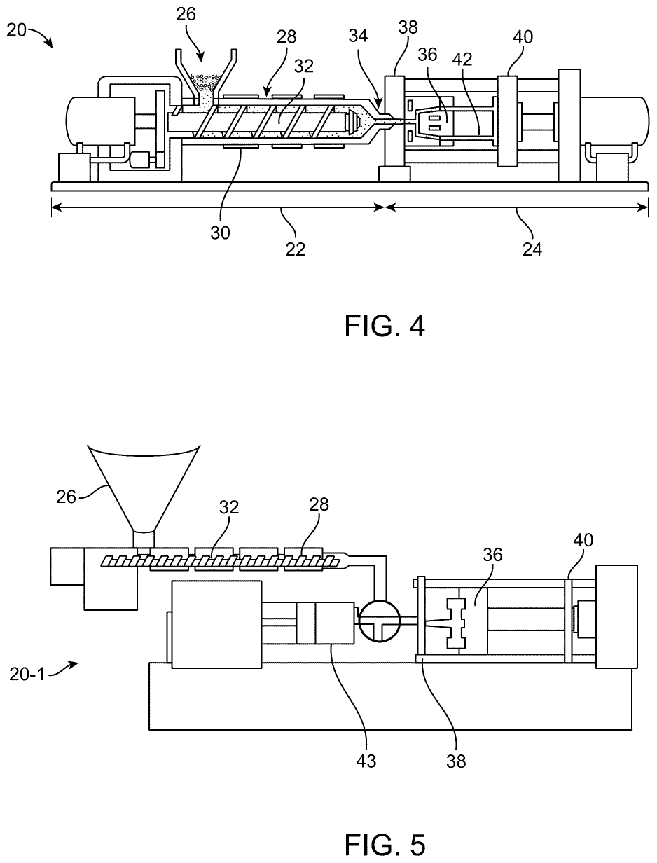

In injection molding, the molten material is injected into a mold. The thermoplastic pellets for the article are fed into a heated barrel, mixed (using a helical screw), and injected into a mold cavity, where it cools and hardens to the configuration of the cavity. Injection molding uses a reciprocating screw to melt and inject the material directly into the mold cavity. FIG. 4 is a schematic illustration of an injection molding machine 20. The machine 20 is generally defined by an injection unit 22 and a clamping unit 24. A feed hopper 26 receives the thermoplastic pellets, with or without the fibers, and transports the material to the barrel 28. A heating unit 30 melts the thermoplastic material with a reciprocating screw 32 mixing and pushing the melt through a nozzle 34 and into a mold 36. The mold 36 is positioned between a stationary platen 38 and a movable platen 40, the movement of which, with the ejector plate 42, released the shaped article from the mold 36.

Like injection molding, transfer injection molding pushes material into a mold through a sprue (i.e., channel through which plastic is poured into a mold), but does so using a plunger instead of a screw injector. That is, in injection transfer molding the material is typically fed into a heated chamber through a screw, and then a plunger forces the material into a mold cavity.

In one embodiment, low pressure injection molding is preferably used to manufacture the article. Low pressure injection molding is a manufacturing process used to produce typically large parts with intricate geometries. As its name states, the main difference with conventional “high pressure” injection molding is the significantly lower pressure used to fill the mold cavity, resulting in a more gentle and controlled filling which in turn reduces the risk of defects such as warping, sink marks, or internal stresses in the finished product. The process typically involves melting plastic pellets in an extruder and filling an accumulator that then acts as a plunger to fill the mold cavity. FIG. 5 is a schematic illustration of a low-pressure injection molding machine 20-1, where like components have the same reference number as the injection molding machine of FIG. 4. FIG. 5 also shows the feed hopper 26, the barrel 28, the reciprocating screw 32, the mold 36, the stationary platen 38, and the movable platen 40. In the variation of the machine 20-1, a transfer cylinder 43 is used to transfer the polymer to the mold 36. The transfer cylinder 43 can be used for application of significantly lower pressure for transfer of the melt for shaping in the mold 36.

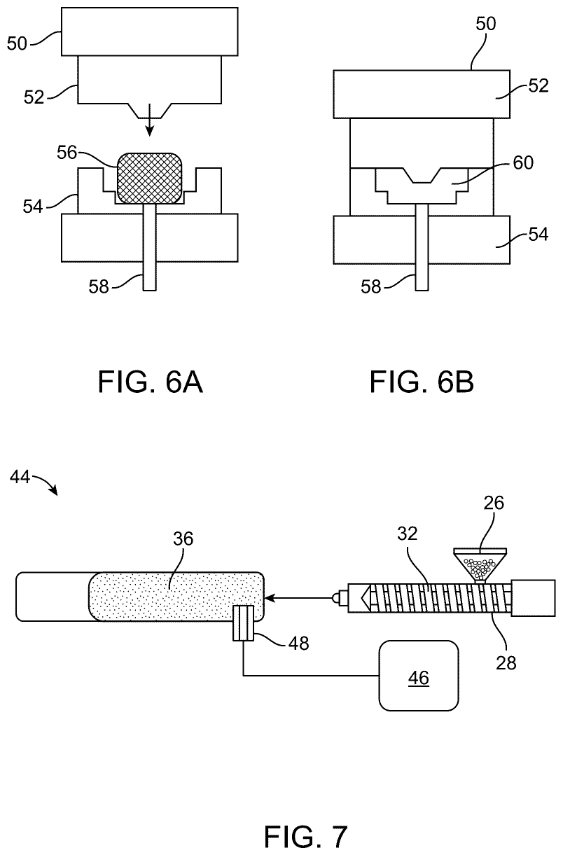

In one embodiment, compression molding is used to manufacture the article. Compression molding uses high pressure and heat, as compared to injection molding that, as described above, uses a melted plastic material that is injected into the mold cavity. Referring to FIGS. 6A and 6B, a compression molding apparatus 50 and general method of operation is illustrated. The exemplary molding apparatus 50 comprises an upper movable mold 52 opposing a lower removable mold 54. A measured amount of the thermoplastic material, with or without fiber, can be preheated. The preheated material is typically referred to as a charge 56, and is placed in an open, heated mold cavity. The charge 56 is compressed into the desired form using the two heated molds 52 and 54. The mold is closed with the top mold 52 applying force to the charge 56, while heat and pressure are maintained until the molding material has cured into a molded article 60. An ejector pin 58 can be used to remove the article 60 from the mold.

Gas-assisted injection molding is a process used in injection molding where an inert gas bubble is injected into the melt stream. FIG. 7 is a schematic illustration of a gas-assisted injection molding machine 44, and also shows the feed hopper 26, the barrel 28, the reciprocating screw 32, and the mold 36. The gas can be injected into the mold 36 or the barrel 28 from a control unit of a gas delivery 46, which meters the injection of the gas from a gas source (not shown). FIG. 7 shows the gas being introduced into the mold 36. Preferably the gas is introduced into the barrel 28 to create a homogenous mixture of the gas and melt of the thermoplastic material. The thermoplastic polymer can be injected up to 85% to 95% of the mold volume, preferably about 88% to 92%, most preferably about 90% of the mold volume - the remaining volume being gas. When the melted thermoplastic in contact with the mold walls begins to solidify, an inert gas, preferably nitrogen gas, is injected into the mold through designed and selected gas inlets. The amount of nitrogen applied can be about 5% to 15% by volume of the total volume of the composition that is added to the mold, or the total volume of the nitrogen and the thermoplastic material (with or without fiber). Preferably, the amount of nitrogen applied can be 8% to 12%, most preferably about 10% by volume of the total volume. The molded article is ejected like the regular injection molding process.

In one embodiment, in addition to an inert gas (e.g., nitrogen), a chemical blowing agent is added to the barrel or the mold. A blowing agent can be any substance that is capable of producing a cellular structure via a foaming process in a variety of materials that undergo hardening or phase transition. In one embodiment, a chemical blowing agent is used but not an inert gas. The chemical blowing agent is added to the barrel or the mold.

### EXAMPLES

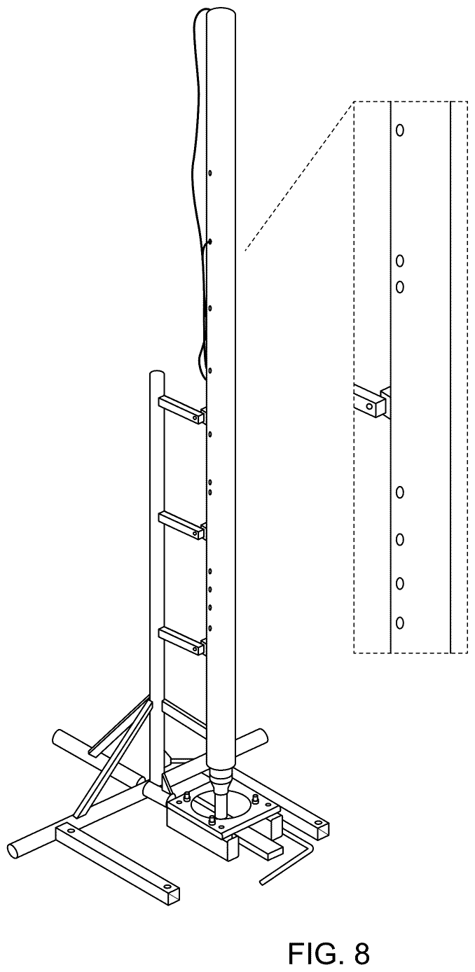

FIG. 8 illustrates an exemplary apparatus constructed for measuring Joules. An aluminum pipe was fixed to a steel frame that was bolted to the ground. Through the pipe, a ram with a total weight of 39.68 Kg. was lifted using a crane and a sling.

Based on the calculations, as is well known in the art, a series of holes were drilled at different heights of the pipe to have a rod pass through to hold the ram at the exact height that would produce the desired impact energy. The aluminum pipe was marked with the amount of Joules at the respective height. The test consisted of a simple manual pull of the rod to let the ram free fall and impact the specimen.

30×24 flat plaques were molded in a 300 tons low pressure injection molding machine. The mold cavity can be shimmed to produce parts in thicknesses that range between 6 mm to 10 mm.

In one sample set, a sheet of reinforced thermoplastic Thermotuff was affixed to the mold cavity using duct tape and polypropylene copolymer was over molded over it, resulting in a dual layer plaque.

In another sample set, the HDPE resin was mixed with an impact modifier which was added in ranges between 5% and 20%.

In order to test for worst case conditions, the plaques were molded using two nozzles to fill the cavity and create a knit line or weld line between the two melt fronts. These plaques were then saw cut for impact testing ensuring that the weld line was diametrical so that the dowel would impact it.

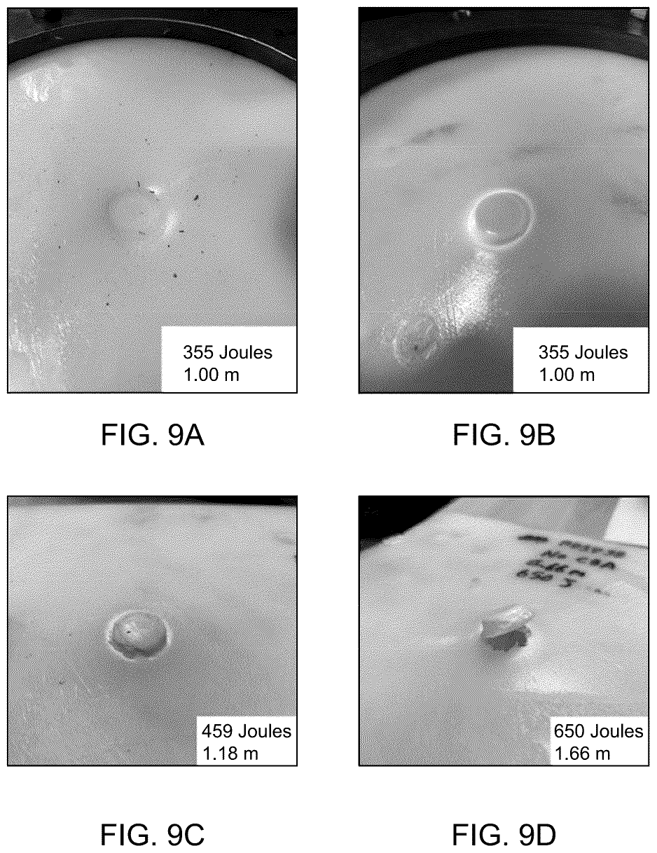

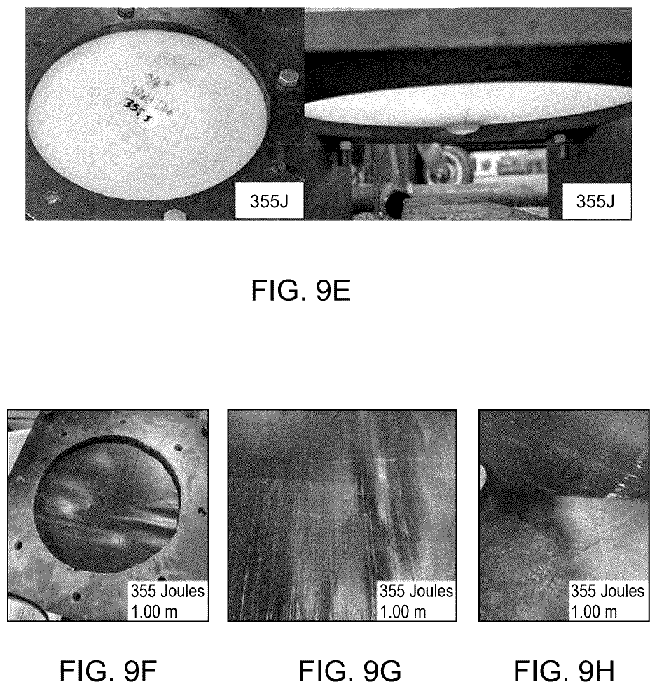

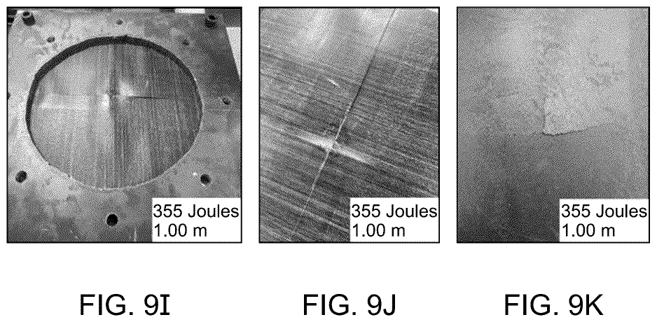

FIGS. 9A and 9K are photographs of the test results. The impact resistant article for a vehicle is configured to absorbed at least 355 and 459 Joules of force without forming an open puncture from an impact surface of the article to an opposing surface of the article.

The coupons provide better scratch resistance, rust resistance, and are quieter than steel. The coupons have a lower co-efficient of friction, allowing the articles to traverse obstacles more fluently than steel and aluminum. A lower friction helps the vehicle maintain its speed without increasing its power, making it more energy and fuel efficient. The articles of the present inventions are less expensive, both in material and manufacturing costs, and lighter in weight per unit than aluminum or steel. The thermoplastic polymers of the present inventions provide greater design flexibility as it is harder to stamp sheet metal or aluminum, and can be readily customized with holes, slots, ribs, mold-in features, and shapes without secondary processes. Installation of the articles of the present invitations requires no welding or specialized equipment, as built-in mounting features can be used to mechanically couple the article to a vehicle. The thermoplastic articles of the present inventions also provide eco-sustainability as compared to steel and aluminum and can be recycled.

While several forms, variations, and embodiments of the inventions have been illustrated and described, it will also be apparent that various modifications can be made without departing from the scope of the inventions. It is also contemplated that various combinations or sub-combinations of the specific features and aspects of the disclosed embodiments can be combined with or substituted for one another to form varying modes of the inventions.

1. A method of manufacturing an impact resistant article for a vehicle, comprising:
injection molding a composition comprising a thermoplastic polymer to produce an impact resistant article for a vehicle configured to absorbed 355 Joules of force without forming an open puncture from an impact surface of the article to an opposing surface of the article.

2. The method of claim 1, wherein the injection molding is conducted in the presence of nitrogen gas in an amount of 5% to 15% by volume of the total volume of the composition.

3. The method of claim 1, wherein the thermoplastic polymer additionally includes glass fiber, wherein the glass fiber is from 30% to 65% by weight of the total weight % of the composition.

4. The method of claim 1, wherein the thermoplastic polymer additionally includes uni-or single directional fiberglass, wherein the fiberglass is from 30% to 65% by weight of the total weight % of the composition.

5. The method of claim 1, wherein the article has an average thickness or a maximum thickness of 3 mm to 14 mm.

6. The method of claim 1, additionally comprising:
shaping the article into a skid plate for an off-road vehicle, wherein the skid plate can absorb 355 Joules of force from a stick or a branch without forming an open puncture from an impact surface of the skid plate to an opposing surface of the skid plate when the off-road vehicle travels at a speed of 16 mph or less.

7. The method of claim 1, wherein the vehicle is a boat hull, and the method additionally comprises shaping the article into a boat hull.

8. The method of claim 1, wherein the thermoplastic polymer is selected from a group consisting of an acrylonitrile butadiene styrene (ABS) homo- or co-polymer, a polypropylene homo- or co-polymer, a polyethylene homo- or co-polymer, a polystyrene homo- or co-polymer, a polyamide homo- or co-polymer, and a high-density polyethylene (HDPE) homo-or co-polymer.

9. An off-road vehicle having a skid plate with an average thickness or maximum thickness of 3 mm to 14 mm for protection of occupants against penetration of objects encountered during normal course of off-road operation made in accordance with the method of claim 1.

10. The off-read vehicle of claim 9, wherein the skid plate prevents penetration of branches and sticks through the skid plate at a speed of up to 16 miles per hour.

11. A method of manufacturing an impact resistant article for a vehicle, comprising:
molding a composition comprising a thermoplastic polymer to produce an article having an average thickness or a maximum thickness of 3 mm to 14 mm and configured to absorbed 355 joules of force without forming an open puncture from an impact surface of the article to an opposing surface of the article.

12. The method of claim 11, wherein the molding includes a molding operation selected from a group consisting of injection molding, transfer injection molding, low pressure injection molding, compression molding, and compression transfer molding.

13. The method of claim 11, wherein the molding is a gas-assisted injection molding process with nitrogen gas being applied in an amount of 5% to 15% by volume of the total volume of the composition.

14. The method of claim 11, wherein the thermoplastic polymer is homopolymer, a copolymer, a random polymer, or a graft polymer having units selected from a group consisting of an acrylic; a polyester; an acrylonitrile butadiene styrene (ABS); a polyamide or a nylon; a polylactic acid or a polylactide; a polybenzimidazole ((PBI); a polycarbonate (PC); a polyether sulfone (PES) or a polysulfone; a polyoxymethylene ((POM); a polyaryletherketone (PAEK); a polyetherimide (PEI); a polyethylene; a polyphenylene oxide (PPO); a polyphenylene sulfide (PPS); a polypropylene (PP); a polystyrene; a polyvinyl; a polyvinyl chloride (PVC); a polyvinylidene fluoride (PVDF); a polytetrafluoroethylene (PTFE); a high-density polyethylene (HDPE), and combination or mixtures thereof.

15. The method of claim 11, wherein the composition additionally includes glass fiber, wherein the glass fiber is from 30% to 65% by weight of the total weight % of the composition.

16. The method of claim 11, wherein the composition additionally includes uni-or single directional fiberglass, wherein the fiberglass is from 30% to 65% by weight of the total weight % of the composition.

17. An off-road vehicle having a skid plate comprising a molded thermoplastic sheet layer or sheet layers,
wherein the skid plate has an average thickness or maximum thickness of 3 mm to 14 mm, and is configured to absorb 355 joules of force without forming an open puncture from an impact surface of the skid plate to an opposing surface of the skid plate; and
wherein the skid plate prevents penetration of branches and sticks through the skid plate at a speed of up to 16 miles per hour.
